(19) United States
(12) Patent Application Publication
(10) Pub. No.: US 2006/0237696 A1
(43) Pub. Date: Oct. 26, 2006

(54) Composition comprising at least one electrophilic monomer and at least one conductive polymer, and cosmetic processes for treating keratin fibers

(76) Inventors: Luc Gourlaouen, Asnieres (FR); Gregory Plos, Tokyo (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 11/393,697

(22) Filed: Mar. 31, 2006

Related U.S. Application Data
(60) Provisional application No. 60/725,289, filed on Oct. 12, 2005.

(30) Foreign Application Priority Data
Mar. 31, 2005 (FR) 05 03151

(51) Int. Cl. H01B 1/12

(52) U.S. Cl. 252/500

(57) ABSTRACT

The present disclosure relates to a composition comprising, in a cosmetically acceptable medium, at least one electrophilic monomer and at least one conductive polymer, and to its use for the cosmetic treatment of keratin fibers. The disclosure also relates to a cosmetic process for treating keratin fibers using the composition.

This application claims benefit of U.S. Provisional Application No. 60/725,259, filed Oct. 12, 2005, the contents of which are incorporated herein by reference. This application also claims benefit of priority under 35 U.S.C. § 119 to French Patent Application No. FR 05 03151, filed Mar. 31, 2005, the contents of which are also incorporated herein by reference.

The present disclosure relates to a composition comprising at least one electrophilic monomer and at least one conductive polymer, to its use for the cosmetic treatment of keratin fibers and to a cosmetic treatment process using such a composition.

In the field of cosmetics, it is sought to modify the surface properties of keratin fibers such as the hair, for example to give the hair a conditioning effect such as softness or sheen. To do this, cosmetic compositions based on conditioning agents such as silicones or polymers that have high affinity for keratin fibers, such as the hair, are generally used.

However, these conditioning agents have a tendency to be removed in the course of washing with shampoo, making it necessary to renew applications of the compositions on the hair.

To increase the remanence of a polymer deposit, it may be envisaged to perform a radical polymerization of certain monomers directly on the hair. However, substantial degradation of the hair fibers is often observed, probably associated with the polymerization initiators, and the hair thus treated can be difficult to disentangle.

The present inventors have found, surprisingly, that by using a combination of at least one conductive polymer with at least one electrophilic monomer as described below, it is possible to obtain improved, long-lasting conditioning and sheen of the hair.

More specifically, it has been found that a composition comprising such a combination makes it possible to maintain the softness and sheen given to a head of hair by the composition, and to do so without reapplication, even after the head of hair has been washed several times.

The application of a composition comprising such a combination may lead to the in situ formation of a lubricant and glossy coating that is remanent, for example, with respect to shampooing.

In addition, this coating may be homogeneous and smooth and show excellent adhesion to keratin fibers.

The combination may also give the head of hair stronger sheen. When used in the presence of dyes or pigments, it makes it possible to obtain greater and long-lasting sheen of the dyed hair, which generally has no more sheen after the first shampoo wash.

One aspect of the present disclosure thus relates to a composition comprising, in a cosmetically acceptable medium, at least one electrophilic monomer and at least one conductive polymer.

Another aspect of the present disclosure relates to a kit comprising the composition for the cosmetic treatment of keratin fibers, such as, for example, the hair.

The present disclosure also relates to a cosmetic process for treating keratin fibers, such as the hair, using the composition.

Other characteristics, aspects and advantages of the present disclosure will emerge even more clearly on reading the description and the examples that follow.

According to the present disclosure, the composition comprises, in a cosmetically acceptable medium, at least one electrophilic monomer and at least one conductive polymer.

For the purposes of the present disclosure, the term “conductive polymer” means a molecular structure in which the monomer or monomers have high electron delocalization and whose arrangement in the polymer skeleton allows the π orbitals to overlap. This chemical characteristic is reflected by electrical conduction, which may or may not be accompanied by absorption in the UV-visible spectrum, or even in the infrared spectrum.

For the purposes of the present disclosure, the expression “conductive polymer absorbing in the visible spectrum” means any conductive polymer having a non-zero absorbance in the wavelength ranging from 400 to 800 nm, even if the absorption maxima of the polymer are outside this range.

The conductive polymers used in the context of the present disclosure may include conductive polymers that are soluble in a cosmetic medium suitable for use. The polymer is said to be soluble in the medium when it forms an isotropic clear liquid at 25° C. in the medium comprising water or a water/solvent mixture, this being obtained throughout all or part of a concentration range of from 0.001% to 50% by weight of conductive polymer.

Furthermore, the polymers may have a conductivity ranging from 10⁻⁵ to 5×10⁵ siemens/cm, such as, for example, from 10⁻³ to 10⁵ siemens/cm or from 10⁻¹ to 10⁴ siemens/cm.

The conductivity is measured using a current generator (RM2 Test Unit sold by the company Jandel) equipped with a four-point measuring head (Universal four-point probes sold by the company Jandel). The four points, aligned and separated by the same space d, are applied by simple pressure to the sample to be analyzed. A current I is injected via the outer points using the current source, thus creating a variation in potential. The voltage U is measured between the two inner points connected to the voltammeter of the current generator.

In this configuration, the conductivity σ of the sample expressed in S/cm is given by the following expression:
σ=(K×I)/(U×e)

wherein:
K is a coefficient depending on the position of the contacts on the surface of the sample. When the points are aligned and equidistant, K is equal to: π/log(2)
I: value of the injected current, expressed in amperes
U: the measured voltage value, expressed in volts
e: thickness of the sample, expressed in cm.

This expression can be used only when the thickness of the material is negligible compared with the distance d existing between two points (e/d<0.25). In order to obtain sufficiently small thicknesses and thus to be able to calculate the conductivity of the material, it is recommended to perform the measurement on a non-conductive support (for example a glass slide) coated with the material to be analyzed, obtained by evaporation of a dilute solution. In order to improve the homogeneity of the coating to be analyzed, it is also recommended to use the centrifugation technique.

According to at least one embodiment of the disclosure, non-limiting mention may be made of conductive polymers that absorb in the visible spectrum and that are chosen from homopolymers and copolymers comprising at least one repeating unit chosen from:

the anilines of formula (I) below:

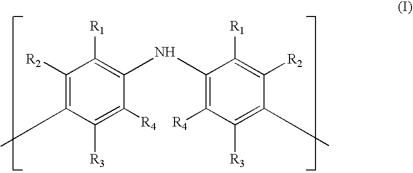

the pyrroles of formulae (IIIa) and (IIb) below:

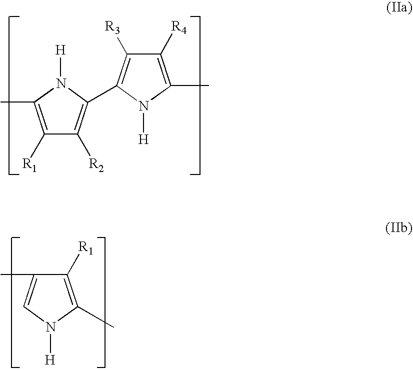

the thiophenes or bisthiophenes of formulae (IIIa), (IIIb) and (IIIc) below:

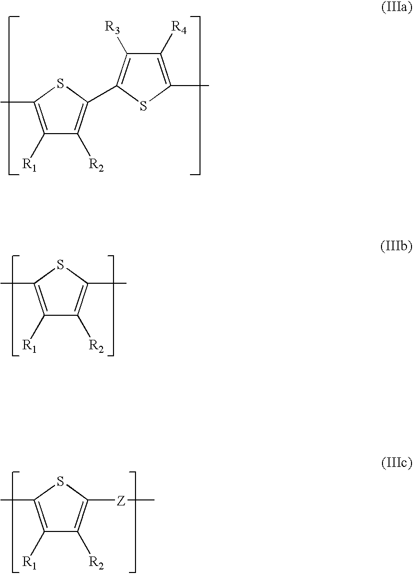

the thiophene-vinylenes of formula (III bis) below:

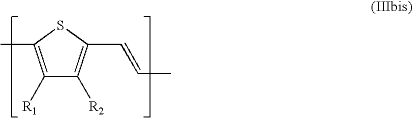

the furans of formula (IV) below:

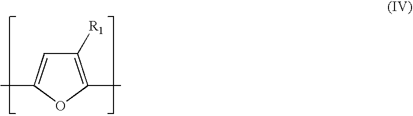

the para-phenylene sulfides of formula (V) below:

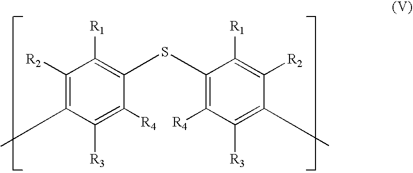

the para-phenylene-vinylenes of formula (VI) below:

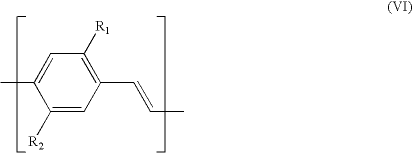

the indoles of formula (VII) below:

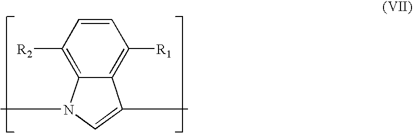

the aromatic amides of formulae (VIIIa), (VIIIb), (VIIIc) and (VIIId) below:

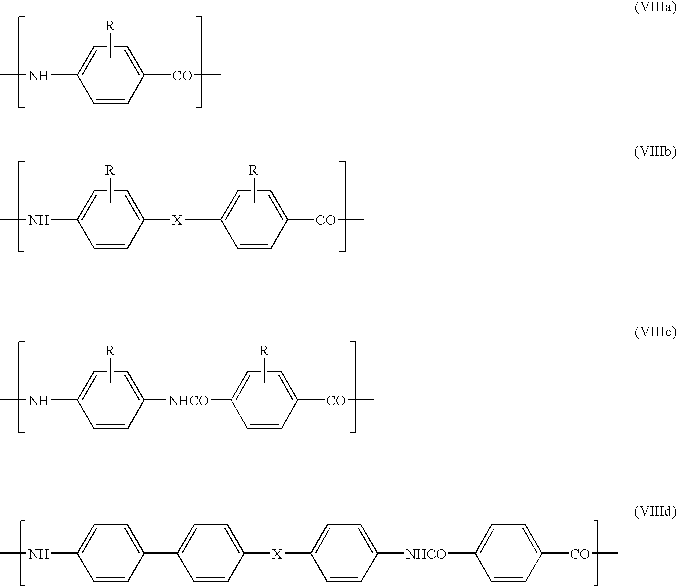

the aromatic hydrazides of formulae (IXa), (IXb) and (IXc) below:

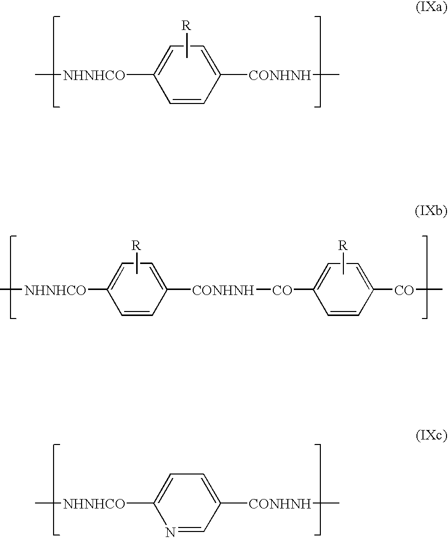

the aromatic azomethines of formulae (Xa), (Xb) and (Xc) below:

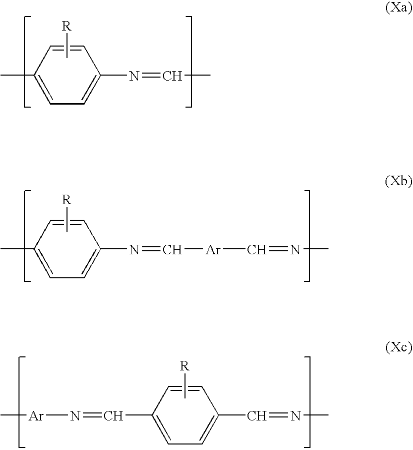

and the aromatic esters of formulae (XIa), (XIb) and (XIc) below:

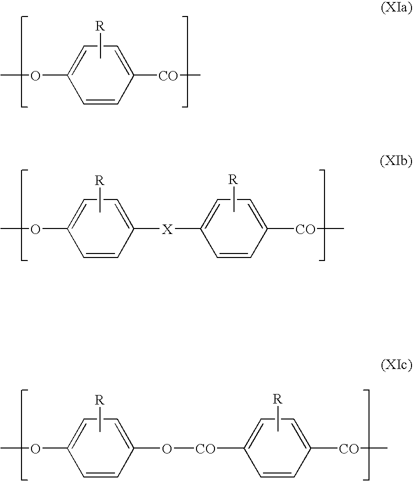

wherein, in formulae (I) to (XI):

the radicals R and R₁ to R₄, which may be identical or different, are chosen from hydrogen, —R′, —OR′, —COOR′ and —OCOR′, wherein R′ is chosen from linear and branched C₁-C₂₀ alkyl radicals, halogen atoms, such as, for example, chlorine, bromine and iodine atoms, nitro radicals, cyano radicals, alkylcyano radicals, and solubilizing groups;

X is chosen from —NHCO—, —O—, —S—, —SO₂—, —N═N—, —C(CH₃)₂—, —CH₂—, —CH═CH—, and —CH═N—;

Z is chosen from —CH═CH— and —C≡C—; and

Ar is chosen from radicals comprising a monoaromatic or polyaromatic radical.

In at least one embodiment, Ar is chosen from at least one radical chosen from the following:

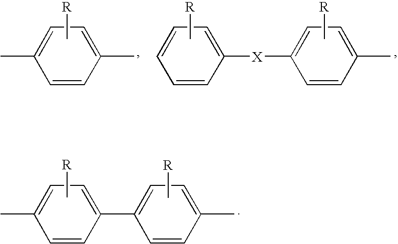

In at least one embodiment, at least one of the radicals R and R₁ to R₄ is a solubilizing group.

For the purposes of the present disclosure, the term “solubilizing group” means a group that ensures the solubilization of the molecule in the cosmetic medium, such that the polymer is of conductive nature after the composition has dried.

In at least one embodiment of the present disclosure the solubilizing groups may be chosen from:
carboxylic acid —COOH functional groups; carboxylate —COO⁻ M⁺ functional groups, wherein M is chosen from alkali metals, such as sodium or potassium; alkaline-earth metals; organic amines, such as primary, secondary or tertiary amines; alkanolamines, and amino acids; and radicals bearing a carboxylic acid (—COOH) or carboxylate (—COO⁻ M⁺ with M as defined above) functional group;
sulfonic acid —SO₃H functional groups; sulfonate —SO₃⁻M⁺ functional groups, wherein M has the same definition as above; and radicals bearing a sulfonic acid (—SO₃H) or sulfonate (—SO₃⁻M⁺, M having the same definition as above) functional group;
primary, secondary and tertiary amine radicals;
quaternary ammonium radicals, such as —NR″₃⁺ Z′⁻, wherein Z′ is chosen from Br, Cl and (C₁-C₄)alkyl-OSO₃ and each R″, which may be identical or different, is chosen from linear and branched C₁ to C₂₀ alkyl radicals, or one R″ may form a heterocycle with another R″ and the nitrogen to which they are attached;
—OH radicals and hydroxylated radicals, such as hydroxy(C₁₋₄ alkyl); and
poly(C₂-C₃ alkene oxide) radicals.

The carboxylic or sulfonic acid functional groups may or may not be neutralized with a base, such as sodium hydroxide, 2-amino-2-methylpropanol, triethylamine or tributylamine.

The amine radicals may or may not be neutralized with a mineral acid, such as hydrochloric acid, or with an organic acid, such as acetic acid or lactic acid.

In addition, in at least one embodiment the solubilizing radicals may be linked to the ring via a spacer group, for instance a radical —R′″—, —OR′″—, —OCOR′″— or —COOR′″—, wherein R′″ is chosen from linear and branched C₁-C₂₀ alkyl radicals optionally comprising at least one hetero atom, such as for instance oxygen.

In at least one embodiment, the radicals R and R₁ to R₄, which may be identical or different, are chosen from hydrogen, R′, —OR′, —OCOR′ and —COOR′, wherein R′ is chosen from linear and branched C₁-C₆ alkyl radical, and from the following neutralized or non-neutralized solubilizing groups: —COOH, —CH₂COOH, —CH₂OH, —(CH₂)₆OH, —(CH₂)₃SO₃H, —O(CH₂)₃SO₃H, —O(CH₂)₃N(C H₂CH₃)₂, —[(CH₂)₂O]ₓCH₂CH₂OH, and —[(CH₂)₂O]ₓCH₂CH₂—OCH₃, wherein x is an average number from 0 to 200.

In at least one embodiment of the present disclosure, the conductive polymer comprises at least one solubilizing group per repeating unit.

The number of repeating units in the polymers of the present disclosure may range from 5 to 10,000, such as, for example, from 5 to 1,000, from 10 to 1,000 or from 20 to 700.

Conductive polymers that may be present in the composition according to the present disclosure are known to those skilled in the art and include those described in the book “Handbook of Organic Conductive Molecules and Polymers”—Wiley 1997—New York, Vol 1, 2, 3, and in the review Can. J. Chem. Vol 64, 1986.

Polythiophenes and their synthesis are described in the article taken from the review Chem. Mater. 1998, Vol. 10, No. 7, pages 1990-1999 by the authors Rasmussen S. C., Pickens J. C. and Hutchison J. E., and titled “A new, general approach to tuning the properties of functionalized polythiophenes: The oxidative polymerization of monosubstituted bithiophenes,” in the article taken from the review Macromolecules 1998, 31, pages 933-936, by the same authors and titled “Highly conjugated, water-soluble polymers via direct oxidative polymerization of monosubstituted bithiophenes.” In addition to polymerization via chemical or electrochemical oxidation, they may also be obtained by polycondensation (dihalothiophene; catalysis with nickel or palladium complexes); via Suzuki coupling (coupling between a halogen function, for example bromine, and a boronic acid, catalysis: palladium complex and base; this then gives coupling of AA-BB type (reaction of monomers of the type A-X-A with B-X′-B) or of A-B type (reaction of several monomers of the type A-X-B); via Stille coupling (formation of a carbon-carbon bond in the presence of a Pd-based catalyst—AA-BB or A-B type); via Reike polymerization (organozinc in the presence of a nickel complex); via polymerization of McCulloch type, etc.

Additional examples of conductive polymers that may be present in the composition according to the present disclosure are described in International Patent Application No. WO 99/47570.

Among the conductive polymers that are may be used according to the present disclosure, non-limiting mention may be made of the polymers corresponding to formulae (IIIa), (IIIb) and (IIIbis) wherein the solubilizing groups are chosen from, for example, carboxylic acid functional groups and groups bearing a carboxylic acid functional group; sulfonic acid functional groups and groups bearing a sulfonic acid functional group; tertiary amine radicals; quaternary ammonium radicals, such as —NR″₃⁺Z⁻, wherein Z is chosen from Br, Cl, and (C₁-C₄)alkyl-OSO₃ and each R″ is chosen from linear and branched C₁ to C₂₀ alkyl groups, which may be identical or different, or one R″ may form a heterocycle with another R″ and the nitrogen to which they are attached; the groups being optionally linked to the ring via a spacer group. The carboxylic or sulfonic acid functional groups may or may not be neutralized.

Thus, the polymerization may be performed via chemical or electrochemical oxidation of the corresponding thiophene monomer or else via polycondensation.

By way of illustration, the polythiophenes of formulae (IIIa) and (IIIb) may be obtained by polymerization via oxidation (for example with FeCl₃ catalysis); via polycondensation of dihalothiophene catalysed with nickel or palladium complexes (e.g.: NiCl₂(dppe)₂); via Suzuki coupling (coupling between a halogen function, for example bromine, and a boronic acid, catalysis: palladium complex and base; this then gives coupling of AA-BB type (reaction of monomers of the type A-X-A with B-X′-B) or of A-B type (reaction of several monomers of the type A-X-B); via Stille coupling (formation of a carbon-carbon bond formed in the presence of a Pd-based catalyst—AA-BB or A-B type); via Reike polymerization (organozinc in the presence of a nickel complex); or via polymerization of McCulloch type, etc.

The vinylene polythiophenes of formula (IIIc) wherein Z is —CH═CH— may be obtained, for example, via Gilch polymerization in the presence of a strong base (potassium tert-butoxide) of 2,5-bis(bromoalkylene)thiophene; via polymerization by the Wessling method via the use of a precursor based on sulfonium salts and pyrolysis; or via a Wittig-Horner Wittig reaction.

The ethynylene polythiophenes of formula (IIIc) with Z representing —C≡C— may be obtained by Heck-Sonogashira coupling (of the type AA-BB or A-B; formation of a carbon-carbon bond between a terminal acetylenic (or true acetylenic) function and a bromo or iodo function, catalysed with a palladium/copper complex (PdCl₂(PPh₃)₃, CuI or Cu(OAc)₂) in the presence of a base such as triethylamine, diisopropyl amine, piperidine, etc.); or via metathesis of alkynes in the presence of a molybdenum complex (Mo(CO)₆).

In general, the functionalization of the polythiophenes, in other words the introduction of the solubilizing or non-solubilizing group(s), may be performed on the monomer before it is polymerized.

In some embodiments of the present disclosure, the solubilizing group is obtained after working up the polymer. This may be the case for the carboxylic acid functional groups, which may be obtained by hydrolysis of the corresponding ester.

In at least one embodiment of the present disclosure, the conductive polymer is chosen from those of formulae (IIIa), (IIIb) and (IIIbis), wherein at least one radical R₁ to R₄ of formula (IIIa) or R₁ or R₂ of formula (IIIb) or (IIIbis) is chosen from solubilizing groups of carboxylic acid type, in neutralized or non-neutralized form, optionally linked to the ring via a spacer group, such as, for example, a linear or branched C₁-C₂₀ alkyl radical, and wherein the other radical(s) represent a hydrogen atom.

In at least one embodiment of the present disclosure, the at least one conductive polymer may be present in the composition in an amount of at least 0.001% by weight, such as, for example, at least 0.01% by weight, at least 0.1% by weight, or at least 0.5% by weight, relative to the total weight of the composition.

In at least one embodiment, the conductive polymer is present in an amount of up to 50% by weight, such as, for example, up to 30% by weight, up to 20% by weight, or up to 10% by weight, relative to the total weight of the composition.

According to at least one embodiment of the present disclosure, the content of the at least one conductive polymer ranges from 0.1% to 50% by weight, such as, for example, from 0.1% to 30% by weight or from 0.5% to 10% by weight, relative to the total weight of the composition.

The term “electrophilic monomer,” as used herein, means a monomer capable of polymerizing via anionic polymerization in the presence of a nucleophilic agent, for instance the hydroxide ions (OH⁻) contained in water at neutral pH.

The term “anionic polymerization,” as used herein, means the mechanism defined in the book “Advanced Organic Chemistry”, Third Edition, by Jerry March, pages 151 to 161.

The electrophilic monomers that may be used in accordance with at least one embodiment of the disclosure are the monomers of structure: 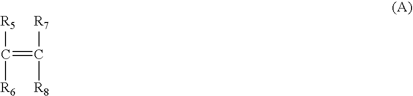
wherein:

R₅ and R₆ are chosen from, independently of each other, sparingly- or non-electron-withdrawing groups (sparingly or non-inductive-withdrawing) such as:
hydrogen atoms,
saturated and unsaturated, linear, branched and cyclic hydrocarbon-based groups containing, for example, from 1 to 20, such as from 1 to 10 carbon atoms, and optionally containing at least one atom chosen from nitrogen, oxygen and sulfur atoms, and optionally substituted with at least one group chosen from —OR₅′, —COOR₅′, —COR₅′, —SH, —SR₅′ and —OH, and halogen atoms,
modified and unmodified polyorganosiloxane residues,
polyoxyalkylene groups,

R₇ and R₈ are chosen from, independently of each other, electron-withdrawing (or inductive-withdrawing) groups chosen from, for example, —N(R₅′)₃⁺, —S(R₅′)₂₊, —SH₂⁺, —NH₃⁺, —NO₂, —SO₂R₅′, —C≡N, —COOH, —COOR₅′, —COSH, —COSR₅′, —CONH₂, —CONHR₅′, —F, —Cl, —Br, —I, —OR₅′, —COR₅′, —SH, —SR₅′ and —OH groups, linear and branched alkenyl groups, linear and branched alkynyl groups, C₁-C₄ mono- and polyfluoroalkyl groups, aryl groups such as phenyl, and aryloxy groups such as phenoxyloxy,

R₅′ is chosen from saturated and unsaturated, linear, branched and cyclic hydrocarbon-based groups including, for example, those containing from 1 to 20 carbon atoms, such as from 1 to 10 carbon atoms, and optionally containing at least one atom chosen from nitrogen, oxygen and sulfur atoms, and optionally substituted with at least one group chosen from —OR₅″, —COOR₅″, —COR₅″, —SH, —SR₅″ and —OH, halogen atoms, and a polymer residue that may be obtained by radical polymerization, by polycondensation or by ring opening, wherein R₅″ is chosen from C₁-C₁₀alkyl groups.

The term “electron-withdrawing or inductive-withdrawing group (−I),” as used herein, means any group that is more electronegative than carbon. Reference may be made to the publication P. R. Wells, Prog. Phys. Org. Chem., Vol. 6, 111 (1968).

The term “sparingly or non-electron-withdrawing group,” as used herein, means any group whose electronegativity is less than or equal to that of carbon.

The alkenyl or alkynyl groups in at least one embodiment contain from 2 to 20 carbon atoms, such as, for example from 2 to 10 carbon atoms.

As saturated or unsaturated, linear, branched or cyclic hydrocarbon-based groups containing from 1 to 20 carbon atoms or from 1 to 10 carbon atoms, non-limiting mention may be made of linear and branched alkyl, alkenyl and alkynyl groups, such as methyl, ethyl, n-butyl, tert-butyl, isobutyl, pentyl, hexyl, octyl, butenyl and butynyl; cycloalkyl and aromatic groups.

Non-limiting examples of substituted hydrocarbon-based groups that may be mentioned include hydroxyalkyl and polyhaloalkyl groups.

Non-limiting examples of unmodified polyorganosiloxanes that may be mentioned include polyalkylsiloxanes such as polydimethylsiloxanes, polyarylsiloxanes such as polyphenylsiloxanes, and polyarylalkylsiloxanes such as polymethylphenylsiloxanes.

Among the modified polyorganosiloxanes that may be used according to at least one embodiment, non-limiting mention may be made of polydimethylsiloxanes containing polyoxyalkylene and/or siloxy and/or silanol and/or amine and/or imine and/or fluoroalkyl groups.

Among the polyoxyalkylene groups that may be used according to at least one embodiment of the present disclosure, non-limiting mention may be made of polyoxyethylene groups and polyoxypropylene groups containing, for example, 1 to 200 oxyalkylene units.

Among the mono- or polyfluoroalkyl groups that may be used according to at least one embodiment, non-limiting mention may be made of groups such as —(CH₂)ₙ—(CF₂)ₘ—CF₃ and —(CH₂)ₙ—(CF₂)ₘ—CHF₂ wherein n=1 to 20 and m=1 to 20.

The substituents R₅ to R₈ may optionally be substituted with a group having cosmetic activity. In at least one embodiment, these cosmetic activities are obtained from groups having coloring, antioxidant, UV-screening and conditioning functions.

As examples of groups having a coloring function, non-limiting mention may be made of azo, quinone, methine, cyanomethine and triarylmethane groups.

As examples of groups having an antioxidant function, non-limiting mention may be made of groups of butylhydroxyanisole (BHA), butylhydroxytoluene (BHT) or vitamin E type.

As examples of groups having a UV-screening function, non-limiting mention may be made of groups of the benzophenone, cinnamate, benzoate, benzylidene-camphor and dibenzoylmethane type.

As examples of groups having a conditioning function, non-limiting mention may be made of cationic groups and groups of fatty ester type.

Among the monomers mentioned above, in at least one embodiment of the present disclosure, further mention may be made of the monomers of the cyanoacrylate family and the derivatives thereof of formula (B):

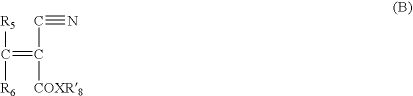

wherein:

X is chosen from NH, S and O,

R₅ and R₆ have the same meanings as above,

R′₈ is chosen from hydrogen atoms and groups R₅′ as defined for formula (A).

In at least one embodiment, X is O.

Compounds of formula (B) that may be mentioned include the monomers:
a) belonging to the family of polyfluoro(C₁-C₂₀)alkyl 2-cyanoacrylates such as: the ester 2,2,3,3-tetrafluoropropyl 2-cyano-2-propenoate of formula: 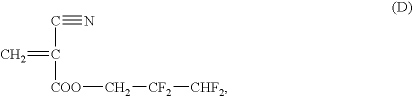
or the ester 2,2,2-trifluoroethyl 2-cyano-2-propenoate of formula: 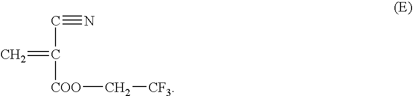
b) the C₁-C₁₀ alkyl or (C₁-C₄ alkoxy)(C₁-C₁₀ alkyl) cyanoacrylates.

Further non-limiting mention may be made of ethyl 2-cyanoacrylate, methyl 2-cyanoacrylate, n-propyl 2-cyanoacrylate, isopropyl 2-cyanoacrylate, tert-butyl 2-cyanoacrylate, n-butyl 2-cyanoacrylate, isobutyl 2-cyanoacrylate, 3-methoxybutyl cyanoacrylate, n-decyl cyanoacrylate, hexyl 2-cyanoacrylate, 2-ethoxyethyl 2-cyanoacrylate, 2-methoxyethyl 2-cyanoacrylate, 2-octyl 2-cyanoacrylate, 2-propoxyethyl 2-cyanoacrylate, n-octyl 2-cyanoacrylate and isoamyl cyanoacrylate.

In at least one embodiment of the disclosure, monomers b) are used.

In at least one embodiment of the present disclosure, the monomers that are chosen from those of formula (F) and mixtures thereof:

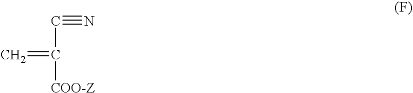

wherein: Z is chosen from —(CH₂)₇—CH₃,
—CH(CH₃)—(CH₂)₅—CH₃,
—CH₂—CH(C₂H₅)—(CH₂)₃—CH₃,
—(CH₂)₅—CH(CH₃)—CH₃,
—(CH₂)₄—CH(C₂H₅)—CH₃.

The monomers used in accordance with the present disclosure may be covalently bonded to supports such as polymers, oligomers or dendrimers. The polymer or the oligomer may be linear, branched, in comb form or in block form. The distribution of the monomers of the present disclosure over the polymeric, oligomeric or dendritic structure may be random, in an end position or in the form of blocks.

The compositions used in accordance with the disclosure may have a concentration of electrophilic monomer according to the disclosure ranging from 0.001% to 80% by weight, such as, for example, from 0.1% to 40% by weight or from 1% to 20% by weight relative to the total weight of the composition.

Polymerization inhibitors and, in at least one embodiment, anionic and/or radical polymerization inhibitors may also be introduced into the compositions, in order to enhance the stability of the composition over time. In a non-limiting manner, the following polymerization inhibitors may be mentioned: sulfur dioxide, nitric oxide, lactone, boron trifluoride, hydroquinone and derivatives thereof such as hydroquinone monoethyl ether, tert-butylhydroquinone (TBHQ), benzoquinone and derivatives thereof such as duroquinone, catechol and derivatives thereof such as t-butylcatechol and methoxycatechol, anisole and derivatives thereof such as methoxyanisole, hydroxyanisole or butylhydroxyanisole, pyrogallol, 2,4-dinitrophenol, 2,4,6-trihydroxybenzene, p-methoxyphenol, hydroxybutyltoluene, alkyl sulfates, alkyl sulfites, alkyl sulfones, alkyl sulfoxides, alkyl sulfides, mercaptans and 3-sulfonene, and mixtures thereof. In at least one embodiment, the alkyl groups are chosen from groups containing 1 to 6 carbon atoms.

It is also possible to use mineral or organic acids, the latter containing at least one carboxylic or sulfonic group, with a pKa ranging from 0 to 6, such as phosphoric acid, hydrochloric acid, nitric acid, benzenesulfonic acid, toluenesulfonic acid, sulfuric acid, carbonic acid, hydrofluoric acid, acetic acid, formic acid, propionic acid, benzoic acid, mono-, di- or trichloroacetic acid, salicylic acid and trifluoroacetic acid.

The amount of inhibitor may range from 10 ppm to 20%, such as, for example, from 10 ppm to 5% or from 10 ppm to 1% by weight relative to the total weight of the composition.

The term “cosmetically acceptable medium,” as used herein, means a medium that is compatible with keratin fibers such as the hair.

In at least one embodiment, the cosmetically acceptable medium is anhydrous. As used herein, the term “anhydrous medium” means a medium containing less than 1% by weight of water relative to the total weight of the composition.

In at least one embodiment of the present disclosure, the cosmetically acceptable medium may be chosen from organic oils; silicones such as volatile silicones, amino or non-amino silicone gums or oils and mixtures thereof; mineral oils; plant oils such as olive oil, castor oil, rapeseed oil, coconut oil, wheatgerm oil, sweet almond oil, avocado oil, macadamia oil, apricot oil, safflower oil, candlenut oil, camelina oil, tamanu oil and lemon oil; waxes; or alternatively organic compounds such as C₅-C₁₀ alkanes, acetone, methyl ethyl ketone, esters of C₁-C₂₀ acids and of C₁-C₈ alcohols such as methyl acetate, butyl acetate, ethyl acetate and isopropylmyristate, dimethoxyethane, diethoxyethane, C₁₀-C₃₀ fatty alcohols such as lauryl alcohol, cetyl alcohol, stearyl alcohol and behenyl alcohol; C₁₀-C₃₀ fatty acids such as lauric acid and stearic acid; C₁₀-C₃₀ fatty amides such as lauric diethanolamide, and C₁₀-C₃₀ fatty alcohol esters such as C₁₀-C₃₀ fatty alcohol benzoates, and mixtures thereof.

In at least one embodiment, the organic compounds are chosen from compounds that are liquid at a temperature of 25° C. and at 10⁵ Pa (760 mmHg).

The compositions in accordance with the present disclosure may also contain at least one agent usually used in cosmetics, chosen, for example, from reducing agents, fatty substances, plasticizers, softeners, antifoams, moisturizers, pigments, clays, mineral fillers, UV-screening agents, mineral colloids, peptizers, solubilizers, fragrances, preserving agents, anionic, nonionic or amphoteric surfactants, fixing or non-fixing polymers, polyols, proteins, vitamins, direct or oxidation dyes, nacreous agents, propellants, and mineral or organic thickeners such as benzylidenesorbitol and N-acylamino acids.

These agents may optionally be encapsulated. The capsule may be of polycyanoacrylate type.

The propellant may be used for the preparation of aerosol compositions. The propellant may comprise compressed and/or liquefied gases that are well known in the art. In at least one embodiment, air, carbon dioxide, compressed nitrogen or a gas such as dimethyl ether, halogenated hydrocarbons, for example fluorinated hydrocarbons, or non-halogenated hydrocarbons, or a mixture thereof, may be used.

The composition may be used on the keratin fibers, such as on the hair, and in at least one embodiment, may be used in the presence of a nucleophilic agent, for cosmetic treatment thereof.

The cosmetic treatment process according to the present disclosure comprises the application of a composition as defined above to the keratin fibers, such as to the hair, in the presence of a nucleophilic agent as defined below.

The nucleophilic agents capable of initiating anionic polymerization are systems that are known, which are capable of generating a carbanion on contact with a nucleophilic agent, such as the hydroxide ions contained in water at neutral pH. As used herein, the term “carbanion” means the chemical species defined in “Advanced Organic Chemistry”, Third Edition, by Jerry March, page 141.

The nucleophilic agents may comprise a molecular compound, an oligomer, a dendrimer or a polymer containing nucleophilic functions. In a non-limiting manner, nucleophilic functions that may be mentioned include the following functions: R^{iv}₂N—, NH₂—, Ph₃C—, R^{iv}₃C—, PhNH⁻, pyridine, ArS⁻, R^{iv}—C═C—, R^{iv}S⁻, SH, R^{iv}O⁻, R^{iv}₂NH, ArO⁻, N₃⁻, OH⁻, ArNH₂, NH₃, I⁻, Br⁻, Cl⁻, R^{iv}COO⁻, SCN⁻, R^{iv}OH, R^{iv}SH, NCO⁻, CN—, NO₃⁻, ClO₄⁻ and H₂O, wherein Ph represents phenyl groups; Ar represents aryl groups and R^{iv} represents C₁-C₁₀ alkyl groups.

In at least one embodiment of the present disclosure, the nucleophilic agent is water. This water may be provided by wetting the fibers beforehand.

lt is also possible, in order to modify the reaction kinetics, to moisten the keratin fibers such as the hair beforehand using an aqueous solution whose pH has been adjusted using a base, an acid or an acid/base mixture. The acid and/or the base may be mineral or organic.

lt is also possible to modify the anionic polymerization kinetics by pre-impregnating the keratin fibers such as the hair with a nucleophilic agent other than water. The nucleophilic agent may be used pure, as a solution or in the form of an emulsion, or may be encapsulated.

To modify the anionic polymerization kinetics, it is also possible to increase the nucelophilicity of the keratin fibers such as the hair via chemical conversion of the keratin fiber.

Examples of chemical conversions that may be mentioned include the reduction of the disulfide bridges of which keratin is partly composed, into thiols, before applying the composition of the disclosure. In a non-exhaustive manner, as reducing agents for the disulfide bridges of which keratin is partly composed, mention may be made of the following compounds:

anhydrous sodium thiosulfate,

powdered sodium metabisulfite,

thiourea,

ammonium sulfite,

thioglycolic acid,

thiolactic acid,

ammonium thiolactate,

glyceryl monothioglycolate,

ammonium thioglycolate,

thioglycerol,

2,5-dihydroxybenzoic acid,

diammonium dithioglycolate,

strontium thioglycolate,

calcium thioglycolate,

zinc formosulfoxylate,

isooctyl thioglycolate,

dl-cysteine,

monoethanolamine thioglycolate.

To modify the anionic polymerization kinetics, such as, for example, to reduce the rate of polymerization of the monomers of the disclosure, it is possible to increase the viscosity of the composition. To do this, at least one polymer that has no reactivity towards the monomers in accordance with the present disclosure may be added to the composition of the disclosure. In this context, mention may be made, in a non-exhaustive manner, of poly(methyl methacrylate) (PMMA) or alternatively cyanoacrylate-based copolymers as described in U.S. Pat. No. 6,224,622.

In order to improve, inter alia, the adhesion of the poly(cyanoacrylate) formed in situ, the fiber may be pretreated with polymers of any type, or a haircare treatment may be performed before applying the composition of the disclosure, for instance a direct dyeing or oxidation dyeing, permanent-waving or hair relaxing operation.

The application of the compositions as described above may or may not be followed by rinsing.

The compositions may be in the form of a lotion, a spray or a mousse, and may be applied as a shampoo or a hair conditioner.

Another aspect of the present disclosure relates to a cosmetic process for treating keratin fibers, comprising at least two steps, one step comprising the application of at least one conductive polymer as defined above, and, with or without intermediate rinsing, another step comprising the application of at least one electrophilic monomer as defined above, the order of the steps being unimportant.

In at least one embodiment of the present disclosure, the cosmetic process comprises the application of the conductive polymer before the application of at least one electrophilic monomer.

In other embodiments of the present disclosure, the cosmetic process comprises the application of at least one electrophilic monomer before the application of at least one conductive polymer.

In at least one embodiment of the disclosure, the process comprises the steps of:

(1) applying to the hair a composition comprising at least one conductive polymer,

(2) applying to the hair, after optional intermediate rinsing, at least one electrophilic monomer.

The order of steps (1) and (2) may be inverted.

Another aspect of the present disclosure relates to a kit comprising a first composition containing at least one electrophilic monomer and optionally at least one anionic and/or radical polymerization inhibitor, and also a second composition comprising, in a cosmetically acceptable medium, at least one conductive polymer that is soluble in the said medium, as defined above.

Other than in the operating examples, or where otherwise indicated, all numbers expressing quantities of ingredients, reaction conditions, and so forth used in the specification and claims are to be understood as being modified in all instances by the term “about.” Accordingly, unless indicated to the contrary, the numerical parameters set forth in the specification and attached claims are approximations that may vary depending upon the desired properties sought to be obtained by the present disclosure. At the very least, and not as an attempt to limit the application of the doctrine of equivalents to the scope of the claims, each numerical parameter should be construed in light of the number of significant digits and ordinary rounding approaches.

Notwithstanding the numerical ranges and parameters setting forth the broad scope of the invention as approximations, the numerical values set forth in the specific examples are reported as precisely as possible. Any numerical value, however, inherently contains certain errors necessarily resulting from the standard deviation found in its respective testing measurement.

The examples that follow are given as illustrations of the invention without, however, being limiting in nature.

In the examples that follow, all the amounts are indicated as weight percentages of active material relative to the total weight of the composition, unless otherwise indicated.

### EXAMPLES

### Example 1

### Preparation of poly(thiophene-3-acetic acid)

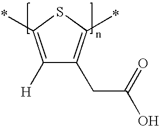

### 1) Preparation of the polymer: poly(ethyl thiophene-3-acetate)

25 ml of dry chloroform were introduced into a Schlenk tube under argon, the solvent was degassed and the following reagents were then introduced:

2.5 g of ethyl thiophene-3-acetate (14.7 mmol)

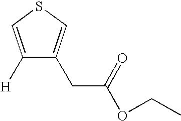

and

1 g of FeCl₃ (6.15 mmol).

The mixture was stirred for 24 hours under argon at 50° C.

The poly(ethyl thiophene-3-acetate) polymer was then precipitated from heptane, after which it was dissolved in a tetrahydrofuran solution.

Characterization by Infrared Spectrometry:

C═O band: 1719 cm⁻¹; CH₂, CH₃ bands=2979 cm⁻¹, 2934 cm⁻¹ and disappearance of the CH band at 3102 cm⁻¹ present in the monomer.

### 2) Hydrolysis of the poly(ethyl thiophene-3-acetate) polymer to form poly(thiophene-3-acetic acid)

The polymer obtained above was hydrolyzed with an excess of 50 ml of an aqueous sodium hydroxide solution (2N) for 48 hours at 70° C., followed by acidification with concentrated HCl up to the point of precipitation of the product: poly(thiophene-3-acetic acid).

The polymer was then filtered off and washed several times with distilled water in order to remove the traces of catalyst.

Characterization of the Polymer by Infrared Spectrometry:

C═O band: 1740 cm⁻¹; COO 1580 cm⁻¹; OH (broad band 3000-3500 cm⁻¹)

### 3) Neutralization of the poly(thiophene-3-acetic acid) polymer

The poly(thiophene-3-acetic acid) polymer (2 g) was dissolved in tetrahydrofuran (30 g) and neutralized with a proportion of 1 mol of sodium hydroxide per mole of carboxylic acid. Water (30 g) was then added. The tetrahydrofuran was evaporated off.

An aqueous 6% solution of poly(thiophene-3-acetic acid) in the form of a sodium salt was thus obtained.

### Example 2

Composition A was prepared from the following ingredients, the proportions being indicated as weight percentages relative to the total weight of the composition:

| | |
|---|---|
| 2-Octyl cyanoacrylate stabilized with 1% phosphoric acid | 10% |
| 50/50 by weight mixture of DC 1501 Fluid (Dow Corning) | 90% |
| (poly(α,ω-dihydroxyldimethylsiloxane/cyclopentadimethyl- | |
| siloxane) (14.7/85.3)) and DC 245 Fluid (Dow Corning) | |
| (cyclopentadimethylsiloxane) | |

Composition B was prepared from the following ingredients, the proportions being indicated as weight percentages relative to the total weight of the composition:

| | |
|---|---|
| Poly(thiophene-3-acetic acid) obtained above | 5 |
| Aminomethylpropanol qs | pH 7 |
| Ethyl alcohol | 15 |
| Water qs | 100 |

0.1 g of composition B described above is applied to 1 g locks of natural chestnut-brown hair at room temperature (20° C.). After a leave-on time of 20 minutes, the lock thus treated was left to dry.

The lock obtained was moistened with water and 0.5 g of composition A was then applied. After a leave-on time of 15 minutes, the lock was dried with a hairdryer.

The locks obtained had a very shiny appearance. To the touch, the hair had the advantage of not being perceived as greasy, and the optical properties observed were maintained on shampooing.

### Example 3

Composition C was prepared from the following ingredients, the proportions being indicated as weight percentages relative to the total weight of the composition:

| | |
|---|---|
| Methyheptyl cyanoacrylate* | 10% |
| 50/50 by weight mixture of DC 1501 Fluid (Dow Corning) | 90% |
| (poly(α,ω-dihydroxyldimethylsiloxane/cyclopentadimethyl- | |
| siloxane) (14.7/85.3)) and DC 245 Fluid (Dow Corning) | |
| (cyclopentadimethylsiloxane) | |

*sold by the society Chemence, UK.

Composition D was prepared from the following ingredients, the proportions being indicated as weight percentages relative to the total weight of the composition:

| | |
|---|---|
| Baytron P* | 80 |
| Water qs | 100 |

*Aqueous dispersion of polyethylene dioxythiophene/polystyrene sulfonate sold by the society BAYER, having a 1.3% dry extract.

0.1 g of composition D described above was applied to 1 g locks of natural chestnut-brown hair at room temperature (20° C.). After a leave-on time of 20 minutes, the lock thus treated was left to dry.

The lock obtained was moistened with water and 0.5 g of composition C was then applied. After a leave-on time of 15 minutes, the lock was dried with a hairdryer.

The locks obtained had a shiny appearance with a coated feeling. To the touch, the hair had the advantage of not being perceived as greasy, and the optical properties and the coating feeling observed were maintained on shampooing.

### Example 4

Composition E was prepared from the following ingredients, the proportions being indicated as weight percentages relative to the total weight of the composition:

| | |
|---|---|
| Methyheptyl cyanoacrylate* | 10% |
| Acetic acid | 0.25% |
| 50/50 by weight mixture of DC 1501 Fluid (Dow Corning) | 89.75% |
| (poly(α,ω-dihydroxyldimethylsiloxane/cyclopentadimethyl- | |
| siloxane) (14.7/85.3)) and DC 245 Fluid (Dow Corning) | |
| (cyclopentadimethylsiloxane) | |

*sold by the society Chemence, UK.

Composition D was prepared from the following ingredients, the proportions being indicated as weight percentages relative to the total weight of the composition:

| | |
|---|---|
| Baytron P* | 80 |
| Water qs | 100 |

*Aqueous dispersion of polyethylene dioxythiophene/polystyrene sulfonate sold by the society BAYER, having a 1.3% dry extract.

0.1 g of composition D described above was applied to 1 g locks of natural chestnut-brown hair at room temperature (20° C.). After a leave-on time of 20 minutes, the lock thus treated was left to dry.

The lock obtained was moistened with water and 0.5 g of composition E was then applied. After a leave-on time of 15 minutes, the lock was dried with a hairdryer.

The locks obtained had a shiny appearance with a coated feeling. To the touch, the hair had the advantage of not being perceived as greasy, and the optical properties and the coating feeling observed were maintained on shampooing.

### Example 5

Composition F was prepared from the following ingredients, the proportions being indicated as weight percentages relative to the total weight of the composition:

| | |
|---|---|
| Methyheptyl cyanoacrylate* | 10% |
| Acetic acid | 0.25% |
| Nacreous mica coating with brown iron oxide, sold by the | 10% |
| society Eckart under the name Prestige Bronze | |
| 50/50 by weight mixture of DC 1501 Fluid (Dow Corning) | 79.75% |
| (poly(α,ω-dihydroxyldimethylsiloxane/cyclopentadimethyl- | |
| siloxane) (14.7/85.3)) and DC 245 Fluid (Dow Corning) | |
| (cyclopentadimethylsiloxane) | |

*sold by the society Chemence, UK.

Composition D was prepared from the following ingredients, the proportions being indicated as weight percentages relative to the total weight of the composition:

| | |
|---|---|
| Baytron P* | 80 |
| Water qs | 100 |

*Aqueous dispersion of polyethylene dioxythiophene/polystyrene sulfonate sold by the society BAYER, having a 1.3% dry extract.

0.1 g of composition D described above was applied to 1 g locks of natural chestnut-brown hair at room temperature (20° C.). After a leave-on time of 20 minutes, the lock thus treated was left to dry.

The lock obtained was moistened with water and 0.5 g of composition F was then applied. After a leave-on time of 15 minutes, the lock was dried with a hairdryer.

The locks obtained were dyed and had a shiny appearance with a coated feeling. To the touch, the hair had the advantage of not being perceived as greasy, and the optical properties and the coating feeling observed, as well as the color of the locks, were maintained on shampooing.

### Example 6

Composition G was prepared from the following ingredients, the proportions being indicated as weight percentages relative to the total weight of the composition:

| | |
|---|---|
| Ethylhexyl cyanoacrylate O-60* | 10% |
| Acetic acid | 0.25% |
| 50/50 by weight mixture of DC 1501 Fluid (Dow Corning) | 89.75% |
| (poly(α,ω-dihydroxyldimethylsiloxane/cyclopentadimethyl- | |
| siloxane) (14.7/85.3)) and DC 245 Fluid (Dow Corning) | |
| (cyclopentadimethylsiloxane) | |

*sold by the society Tong Shen, China.

Composition D was prepared from the following ingredients, the proportions being indicated as weight percentages relative to the total weight of the composition:

| | |
|---|---|
| Baytron P* | 80 |
| Water qs | 100 |

*Aqueous dispersion of polyethylene dioxythiophene/polystyrene sulfonate sold by the society BAYER, having a 1.3% dry extract.

0.1 g of composition D described above was applied to 1 g locks of natural chestnut-brown hair at room temperature (20° C.). After a leave-on time of 20 minutes, the lock thus treated was left to dry.

The lock obtained was moistened with water and 0.5 g of composition G was then applied. After a leave-on time of 15 minutes, the lock was dried with a hairdryer.

The locks obtained had a shiny appearance with a coating feeling. To the touch, the hair had the advantage of not being perceived as greasy, and the optical properties and the coating feeling observed were maintained on shampooing.

What is claimed is:

1. A composition comprising, in a cosmetically acceptable medium, at least one electrophilic monomer and at least one conductive polymer.

2. The composition according to claim 1, wherein the at least one conductive polymer is chosen from homopolymers and copolymers comprising at least one repeating unit chosen from:
anilines of formula (I): 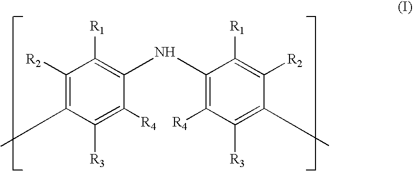
pyrroles of formulae (IIa) and (IIb): 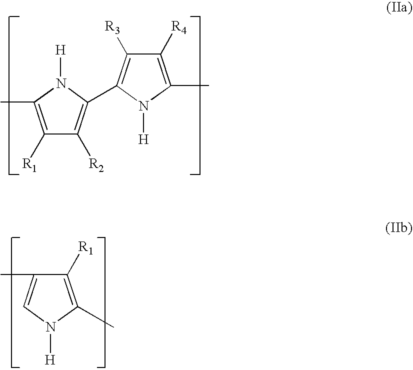
thiophenes and bisthiophenes of formulae (IIIa), (IIIb) and (IIIc): 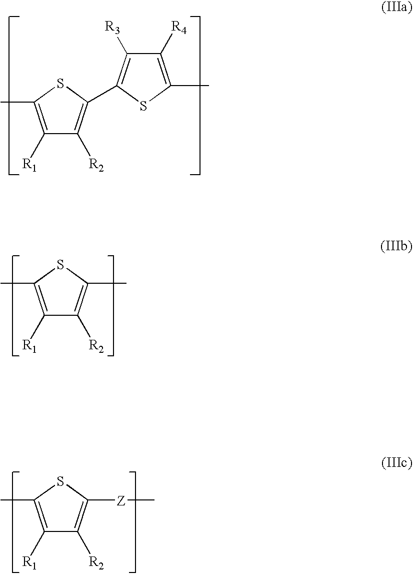
thiophene-vinylenes of formula (III bis): 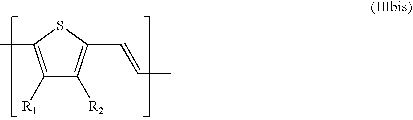
furans of formula (IV): 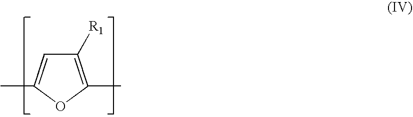
para-phenylene sulfides of formula (V): 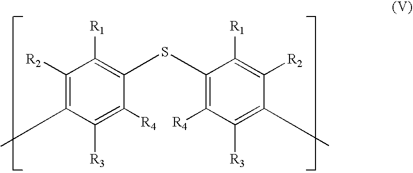
para-phenylene-vinylenes of formula (VI): 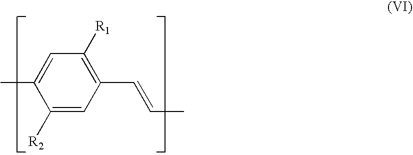
indoles of formula (VII): 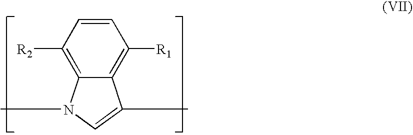
aromatic amides of formulae (VIIIa), (VIIIb), (VIIIc) and (VIIId): 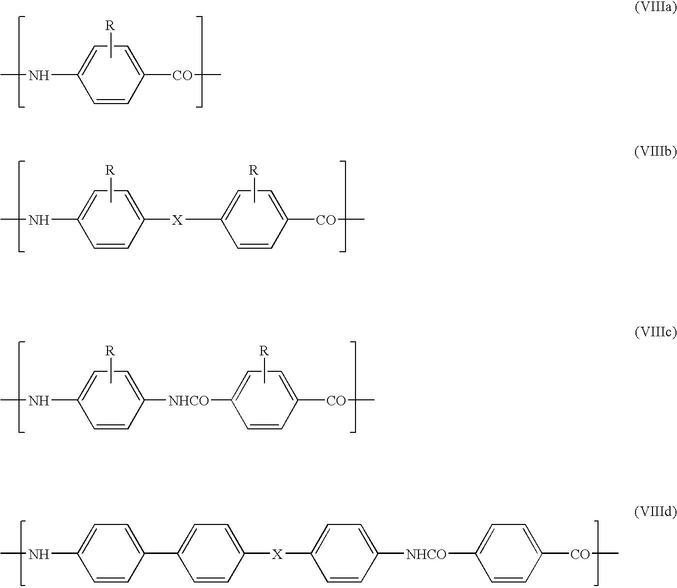
aromatic hydrazides of formulae (IXa), (IXb) and (IXc): 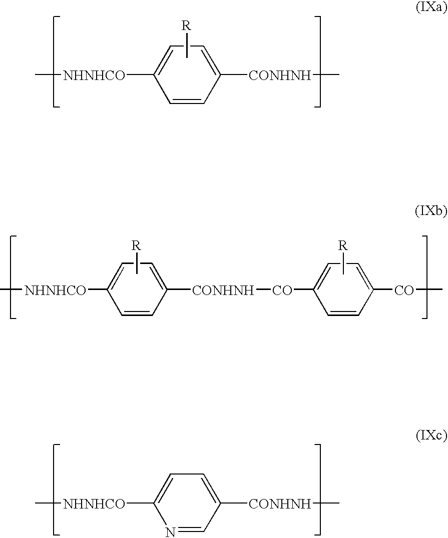
aromatic azomethines of formulae (Xa), (Xb) and (Xc): 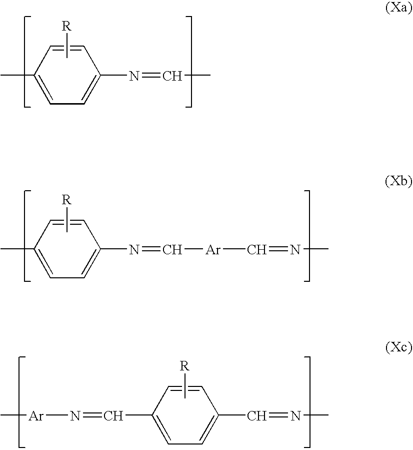
aromatic esters of formulae (XIa), (XIb) and (XIc): 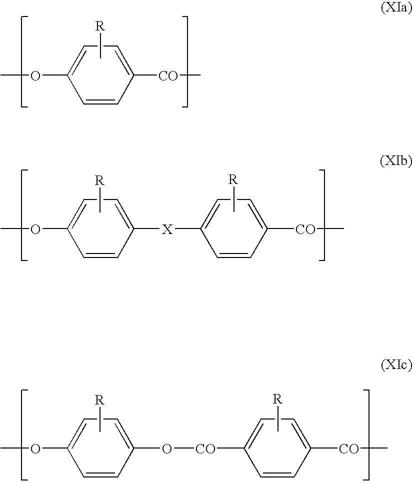
wherein, in formulae (I) to (XI):
the radicals R_{and R}₁ to R₄, which may be identical or different, are chosen from hydrogen, —R′, —OR′, —COOR′ and —OCOR′, wherein R′ is chosen from linear and branched C₁-C₂₀ alkyl radicals, halogen atoms, nitro radicals, cyano radicals, alkylcyano radicals, and solubilizing groups;
X is chosen from —NHCO—, —O—, —S—, —SO₂—, —N═N—, —C(CH₃)₂—, —CH₂—, —CH═CH—, and —CH═N—;
Z is chosen from —CH═CH— and —C≡C—; and
Ar is chosen from radicals comprising a monoaromatic or polyaromatic radical.

3. The composition according to claim 2, wherein at least one of the groups R and R₁ to R₄ is a solubilizing group.

4. The composition according to claim 2, wherein the solubilizing group is chosen from:
carboxylic acid —COOH functional groups; carboxylate —COO⁻ M⁺ functional groups, wherein M is chosen from alkali metals, alkaline-earth metals, and organic amines; and radicals bearing a carboxylic acid or carboxylate functional group;
sulfonic acid —SO₃H functional groups; sulfonate —SO₃— M+functional groups, wherein M has the same definition as above; and radicals bearing a sulfonic acid or sulfonate functional group;
primary, secondary and tertiary amine radicals;
quaternary ammonium radicals;
—OH radicals and hydroxylated radicals; and
poly(C₂-C₃ alkene oxide) radicals.

5. The composition according to claim 4, wherein the organic amines are chosen from primary, secondary and tertiary amines; alkanolamines; and amino acids.

6. The composition according to claim 4, wherein the quaternary ammonium radicals are chosen from —NR₁₃+Z′⁻ radicals, wherein Z′ is chosen from Br, Cl and (C₁-C₄)alkyl-OSO₃, and each R″, which may be identical or different, is chosen from linear and branched C₁ to C₂₀ alkyl radicals, or one R″ may form a heterocycle with another R″ and the nitrogen to which they are attached.

7. The composition according to claim 1, wherein the at least one conductive polymer comprises at least one solubilizing group per repeating unit.

8. The composition according to claim 2, wherein the at least one conductive polymer is chosen from homopolymers and copolymers comprising at least one repeating unit chosen from formulae (IIIa), (IIIb) and (IIIbis), wherein at least one radical R₁ to R₄ of formulae (IIIa), or R₁ or R₂ of formula (IIIb) or (IIIbis) is a solubilizing group of carboxylic acid type, in neutralized or non-neutralized form, optionally linked to the ring via a spacer group, and the other radical(s) R₁ to R₄ of formulae (IIIa), or R₁ or R₂ of formula (IIIb) or (IIIbis) are hydrogen atoms.

9. The composition according to claim 8, wherein the spacer group is chosen from linear and branched C₁-C₂₀ alkyl radicals.

10. The composition according to claim 1, wherein the at least one conductive polymer is soluble in the cosmetically acceptable medium.

11. The composition according to claim 1, wherein the at least one conductive polymer is present in an amount of at least 0.001% by weight relative to the total weight of the composition.

12. The composition according to claim 11, wherein the at least one conductive polymer is present in an amount of at least 0.01% by weight relative to the total weight of the composition.

13. The composition according to claim 1, wherein the at least one conductive polymer is present in an amount of not more than 50% by weight relative to the total weight of the composition.

14. The composition according to claim 13, wherein the at least one conductive polymer is present in an amount of not more than 30% by weight relative to the total weight of the composition.

15. The composition according to claim 1, wherein the at least one electrophilic monomer is chosen from compounds of formula (A): 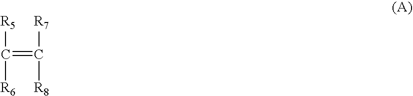
wherein:
R₅ and R₆ are chosen from, independently of each other, sparingly- and non-electron-withdrawing groups chosen from:
hydrogen atoms,
saturated and unsaturated, linear, branched and cyclic hydrocarbon-based groups containing from 1 to 20 carbon atoms, and optionally containing at least one atom chosen from nitrogen, oxygen and sulfur atoms, and optionally substituted with at least one group chosen from —OR₅′, —COOR₅′, —COR₅′, —SH, —SR₅′ and —OH, and halogen atoms,
modified and unmodified polyorganosiloxane residues,
polyoxyalkylene groups,
R₇ and R₈ are chosen from, independently of each other, electron-withdrawing groups chosen from —N(R₅′)₃⁺, —S(R₅′)₂⁺, —SH₂⁺, —NH₃⁺, —NO₂, —SO₂R₅′, —C—N, —COOH, —COOR₅′, —COSH, —COSR₅′, —CONH₂, —CONHR₅′, —F, —Cl, —Br, —I, —OR₅′, —COR₅′, —SH, —SR₅′ and —OH groups, linear and branched alkenyl groups, linear and branched alkynyl groups, C₁-C₄ mono- and polyfluoroalkyl groups, aryl groups and aryloxy groups, R₅″ is chosen from saturated and unsaturated, linear, branched and cyclic hydrocarbon-based groups containing from 1 to 20 carbon atoms, and optionally containing at least one atom chosen from nitrogen, oxygen and sulfur atoms, and optionally substituted with at least one group chosen from —OR₅″, —COOR₅″, —COR₅″, —SH, —SR₅″ and —OH, halogen atoms, and polymer residues that may be obtained by radical polymerization, by polycondensation or by ring opening, wherein R₅″ is chosen from C₁-C₁₀ alkyl groups.

16. The composition according to claim 15, wherein the at least one electrophilic monomer is chosen from the compounds of formula (B): 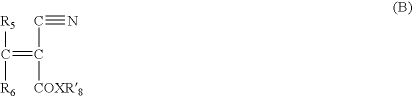
X is chosen from NH, S and O,
R₅ and R₆ are as defined in claim 15,
R′₈ is chosen from hydrogen atoms groups R₅′ as defined in claim 15.

17. The composition according to claim 16, wherein the at least one electrophilic monomer is chosen from polyfluoro(C₁-C₂₀)alkyl 2-cyanoacrylates and (C₁-C₁₀)alkyl or (C₁-C₄ alkoxy)(C₁-C₁₀ alkyl) cyanoacrylates.

18. The composition according to claim 17, wherein the at least one electrophilic monomer is chosen from ethyl 2-cyanoacrylate, methyl 2-cyanoacrylate, n-propyl 2-cyanoacrylate, isopropyl 2-cyanoacrylate, tert-butyl 2-cyanoacrylate, n-butyl 2-cyanoacrylate, isobutyl 2-cyanoacrylate, 3-methoxybutyl cyanoacrylate, n-decyl cyanoacrylate, hexyl 2-cyanoacrylate, 2-ethoxyethyl 2-cyanoacrylate, 2-methoxyethyl 2-cyanoacrylate, 2-octyl 2-cyanoacrylate, 2-propoxyethyl 2-cyanoacrylate, n-octyl 2-cyanoacrylate and isoamyl cyanoacrylate.

19. The composition according to claim 18, wherein the at least one electrophilic monomer is chosen from compounds of formula (F): 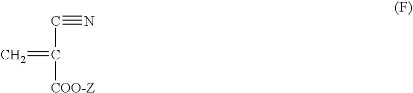
wherein Z is chosen from:
—(CH₂)₇—CH₃,
—CH(CH₃)—(CH₂)₅—CH₃,
—CH₂—CH(C₂H₅)—(CH₂)₃—CH₃,
—(CH₂)₅—CH(CH₃)—CH₃, and
—(CH₂)₄—CH(C₂H₅)—CH₃.

20. The composition according to claim 1, wherein the at least one electrophilic monomer is covalently bonded to a support.

21. The composition according to claim 20, wherein the support is chosen from polymers, oligomers, and dendrimers.

22. The composition according to claim 1, where the at least one electrophilic monomer is present in an amount ranging from 0.001% to 80% by weight relative to the total weight of the composition.

23. The composition according to claim 22, wherein the at least one electrophilic monomer is present in an amount ranging from 0.1% to 40% by weight relative to the total weight of the composition.

24. The composition according to claim 1, wherein the cosmetically acceptable medium is anhydrous.

25. The composition according to claim 24, wherein the cosmetically acceptable medium is chosen from organic oils, silicones, mineral oils, plant oils, waxes, C₅-C₁₀ alkanes, acetone, methyl ethyl ketone, esters of C₁-C₂₀ acids, esters of C₁-C₈ alcohols, dimethoxyethane, diethoxyethane, C₁₀-C₃₀ fatty alcohols, C₁₀-C₃₀ fatty acids, C₁₀-C₃₀ fatty amides and C₁₀-C₃₀ fatty alcohol esters, and mixtures thereof.

26. The composition according to claim 1, further comprising at least one polymerization inhibitor.

27. The composition according to claim 26, wherein the at least one polymerization inhibitor is chosen from anionic and radical polymerization inhibitors.

28. The composition according to claim 26, wherein the at least one polymerization inhibitor is chosen from sulfur dioxide, nitric oxide, lactone, boron trifluoride, hydroquinone and derivatives thereof, tert-butylhydroquinone (TBHQ), benzoquinone and derivatives thereof, catechol and derivatives thereof, anisole and derivatives thereof, pyrogallol, 2,4-dinitrophenol, 2,4,6-trihydroxybenzene, p-methoxyphenol, hydroxybutyl-toluene, alkyl sulfates, alkyl sulfites, alkyl sulfones, alkyl sulfoxides, alkyl sulfides, mercaptans and 3-sulfonene, and mixtures thereof.

29. The composition according to claim 28, wherein the hydroquinone derivative is hydroquinone monoethyl ether.

30. The composition according to claim 28, wherein the benzoquinone derivative is duroquinone.

31. The composition according to claim 28, wherein the catechol derivatives are chosen from t-butylcatechol and methoxycatechol.

32. The composition according to claim 28, wherein the anisole derivates are chosen from methoxyanisole, hydroxyanisole and butylhydroxyanisole.

33. The composition according to claim 26, wherein the at least one polymerization inhibitor is present in an amount ranging from 10 ppm to 20% relative to the total weight of the composition.

34. The composition according to claim 1, further comprising at least one agent chosen from reducing agents, fatty substances, plasticizers, softeners, antifoams, moisturizers, pigments, clays, mineral fillers, UV-screening agents, mineral colloids, peptizers, solubilizers, fragrances, preserving agents, anionic, nonionic and amphoteric surfactants, fixing and non-fixing polymers, polyols, proteins, vitamins, direct and oxidation dyes, and nacreous agents.

35. The composition according to claim 34, wherein the at least one agent is encapsulated.

36. A cosmetic process for treating keratin fibers, comprising applying a composition to the keratin fibers in the presence of a nucleophilic agent, wherein the composition comprises, in a cosmetically acceptable medium, at least one electrophilic monomer and at least one conductive polymer.

37. The process according to claim 36, wherein the nucleophilic agent is chosen from molecular compounds, oligomers, dendrimers and polymers containing nucleophilic functions chosen from: R^{iv}₂N⁻, NH₂⁻, Ph₃C⁻, R^{iv}₃C⁻, PhNH⁻, pyridine, ArS⁻, R^{iv}—C≡C⁻, R^{iv}S⁻, SH, R^{iv}O⁻, R^{iv}₂NH, ArO⁻, N₃⁻, OH⁻, ArNH₂, NH₃, I⁻, Br⁻, Cl⁻, R^{iv}COO⁻, SCN⁻, R^{iv}OH, R^{iv}SH, NCO⁻, CN⁻, NO₃⁻, ClO₄⁻ and H₂O, wherein Ph is a phenyl group; Ar is an aryl group and R^{iv} is a C₁-C₁₀ alkyl group.

38. The process according to claim 37, wherein the nucleophilic agent is water.

39. The process according to claim 36, comprising, before applying said composition, pre-moistening the keratin fibers with an aqueous solution whose pH has been adjusted using a base, an acid or an acid/base mixture.

40. The process according to claim 36, wherein the keratin fibers are pre-impregnated using a nucleophilic agent other than water.

41. The process according to claim 36, wherein the keratin fibers are reduced before application of the composition.

42. The process according to claim 36, wherein the application of the composition is followed by rinsing.

43. The process according to claim 36, wherein the keratin fibers are hair.

44. A cosmetic process for treating keratin fibers, comprising:
applying at least one conductive polymer, and, with or without an optional intermediate rinsing step,
applying at least one electrophilic monomer
wherein:
the at least one conductive polymer is chosen from homopolymers and copolymers comprising at least one repeating unit chosen from:
anilines of formula (1): 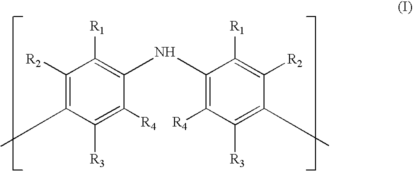
pyrroles of formulae (IIa) and (IIb): 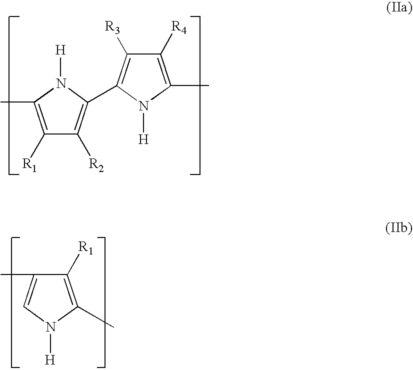
thiophenes and bisthiophenes of formulae (IIIa), (IIIb) and (IIIc): 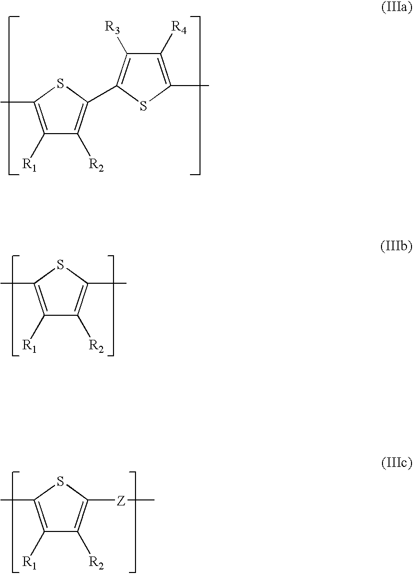
thiophene-vinylenes of formula (III bis): 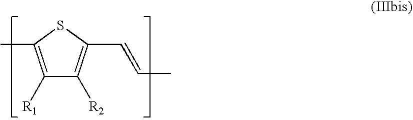
furans of formula (IV): 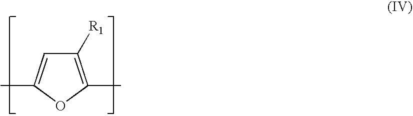
para-phenylene sulfides of formula (V): 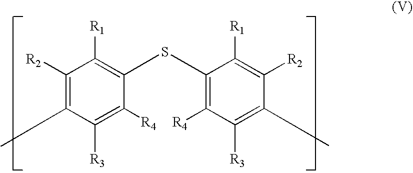
para-phenylene-vinylenes of formula (VI): 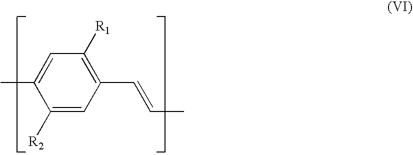
indoles of formula (VII): 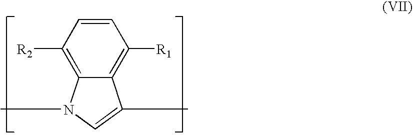
aromatic amides of formulae (VIIIa), (VIIIb), (VIIIc) and (VIIId): 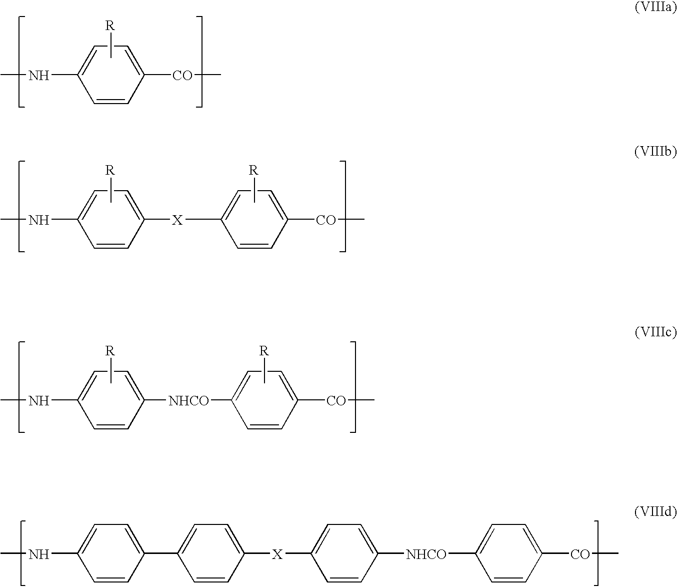
aromatic hydrazides of formulae (IXa), (IXb) and (IXc): 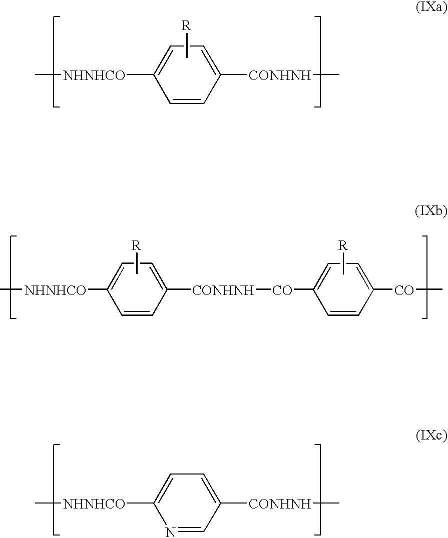
aromatic azomethines of formulae (Xa), (Xb) and (Xc): 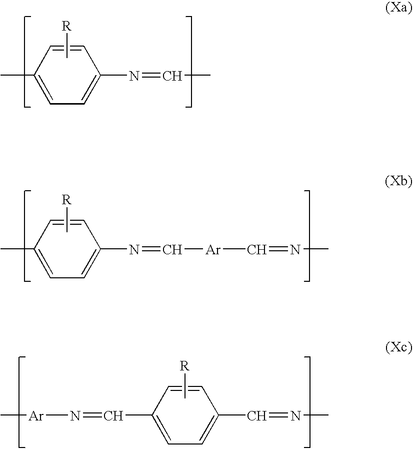
aromatic esters of formulae (XIa), (XIb) and (XIc): 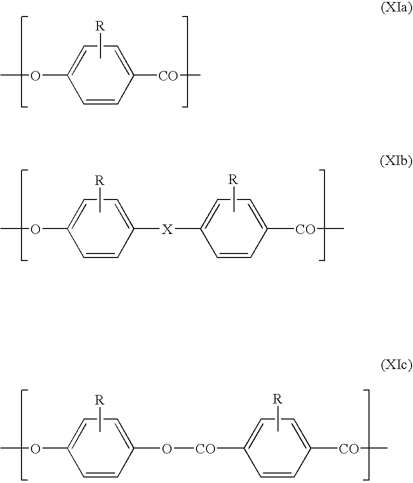
wherein, in formulae (I) to (XI):
the radicals R and R₁ to R₄, which may be identical or different, are chosen from hydrogen, —R′, —OR′, —COOR′ and —OCOR′, wherein R′ is chosen from linear and branched C₁-C₂₀ alkyl radicals, halogen atoms, nitro radicals, cyano radicals, alkylcyano radicals, and solubilizing groups;
X is chosen from —NHCO—, —O—, —S—, —SO₂—, —N═N—, —C(CH₃)₂—, —CH₂—, —CH═CH—, and —CH═N—;
Z is chosen from —CH═CH— and —C≡C—; and
Ar is chosen from radicals comprising a monoaromatic or polyaromatic radical; and
the at least one electrophilic monomer is chosen from compounds of formula (A): 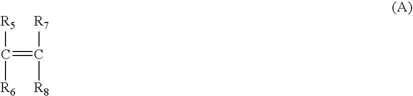
wherein:
—R₅ and R₆ are chosen from, independently of each other, sparingly- and non-electron-withdrawing groups chosen from:
hydrogen atoms,
saturated and unsaturated, linear, branched and cyclic hydrocarbon-based groups containing from 1 to 20 carbon atoms, and optionally containing at least one atom chosen from nitrogen, oxygen and sulfur atoms, and optionally substituted with at least one group chosen from —OR₅′, —COOR₅′, —COR₅′, —SH, —SR₅′ and —OH, and halogen atoms,
modified and unmodified polyorganosiloxane residues,
polyoxyalkylene-groups,
R₇ and R₈ are chosen from, independently of each other, electron-withdrawing groups chosen from —N(R₅′)₃⁺, —S(R₅′)₂⁺, —SH₂⁺, —NH₃⁺, —NO₂, —SO₂R₅′, —C≡N, —COOH, —COOR₅′, —COSH, —COSR₅′, —CONH₂, —CONHR₅′, —F, —Cl, —Br, —I, —OR₅′, —COR₅′, —SH, —SR₅′ and —OH groups, linear and branched alkenyl groups, linear and branched alkynyl groups, C₁-C₄ mono- and polyfluoroalkyl groups, aryl groups and aryloxy groups,
wherein R₅′ is chosen from saturated and unsaturated, linear, branched and cyclic hydrocarbon-based groups containing from 1 to 20 carbon atoms, and optionally containing at least one atom chosen from nitrogen, oxygen and sulfur atoms, and optionally substituted with at least one group chosen from —OR₅″, —COOR₅″, —COR₅″, —SH, —SR₅″ and —OH, halogen atoms, and polymer residues that may be obtained by radical polymerization, by polycondensation or by ring opening, wherein R₅″ is chosen from C₁-C₁₀alkyl groups.

45. The process according to claim 44, wherein the application of the at least one conductive polymer is performed before the application of the at least one electrophilic monomer.

46. The process according to claim 44, wherein the application of the at least one electrophilic monomer is performed before the application of the at least one conductive polymer.

47. A kit comprising a first composition containing at least one electrophilic monomer and a second composition comprising, in a cosmetically acceptable medium, at least one conductive polymer, wherein the at least one conductive polymer is chosen from homopolymers and copolymers comprising at least one repeating unit chosen from:
anilines of formula (I): 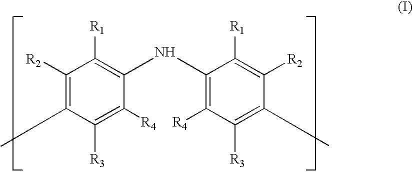
pyrroles of formulae (IIa) and (IIb): 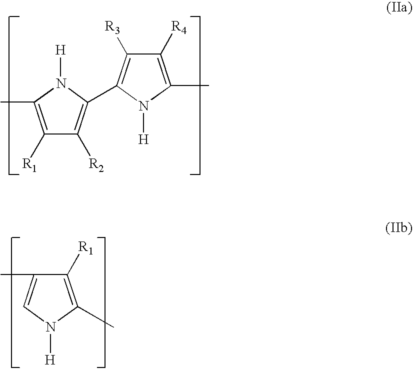
thiophenes and bisthiophenes of formulae (IIIa), (IIIb) and (IIIc): 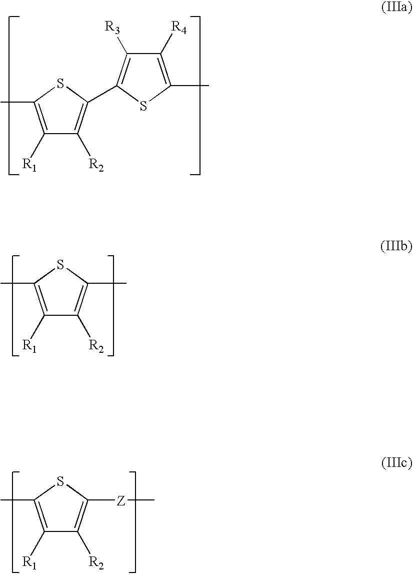
thiophene-vinylenes of formula (III bis): 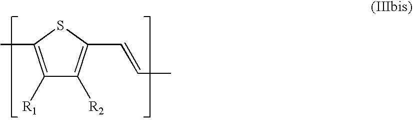
furans of formula (IV): 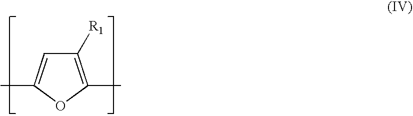
para-phenylene sulfides of formula (V): 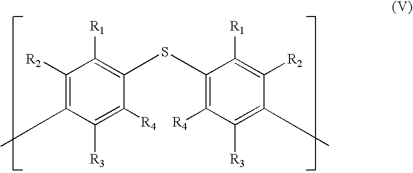
para-phenylene-vinylenes of formula (VI): 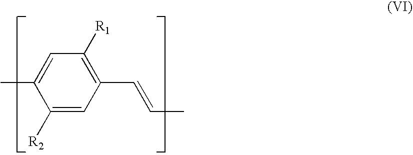
indoles of formula (VI): 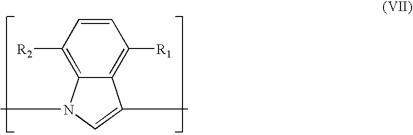
aromatic amides of formulae (VIIIa), (VIIIb), (VIIIc) and (VIIId): 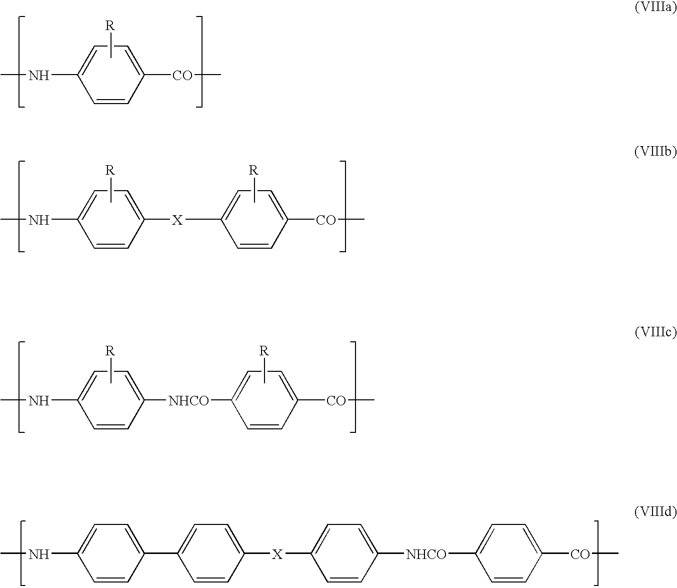
aromatic hydrazides of formulae (IXa), (IXb) and (IXc): 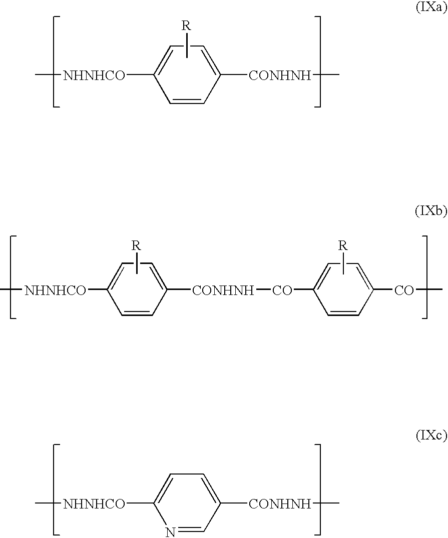
aromatic azomethines of formulae (Xa), (Xb) and (Xc): 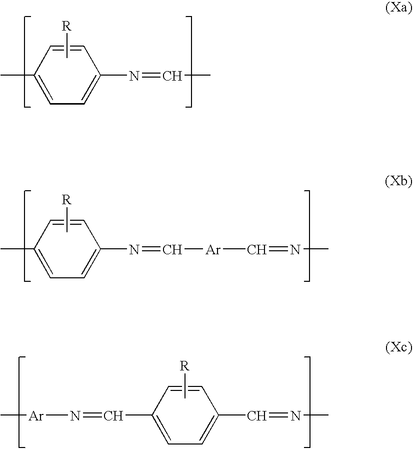
aromatic esters of formulae (XIa), (XIb) and (XIc): 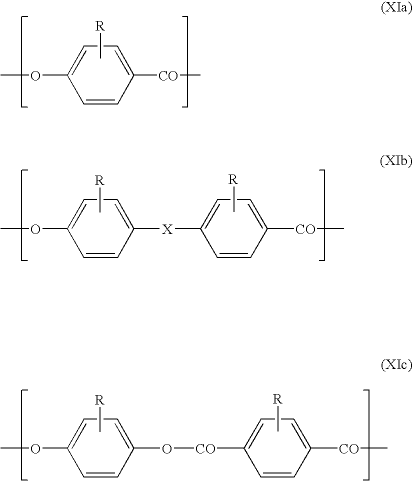
wherein, in formulae (I) to (XI):
the radicals R and R₁ to R₄, which may be identical or different, are chosen from hydrogen, —R′, —OR′, —COOR′ and —OCOR′, wherein R′ is chosen from linear and branched C₁-C₂₀ alkyl radicals, halogen atoms, nitro radicals, cyano radicals, alkylcyano radicals, and solubilizing groups;
X is chosen from —NHCO—, —O—, —S—, —SO₂—, —N═N—, —C(CH₃)₂—, —CH₂—, —CH═CH—, and —CH═N—;
Z is chosen from —CH═CH— and —C≡C—; and
Ar is chosen from radicals comprising a monoaromatic or polyaromatic radical.
